(19) United States
(12) Patent Application Publication
(10) Pub. No.: US 2017/0023200 A1
(43) Pub. Date: Jan. 26, 2017

(54) HEADLAMP ASSEMBLY

(71) Applicant: Ford Global Technologies, LLC, Dearborn, MI (US)

(72) Inventors: Chad Clement, Belleville, MI (US); Udayakumar Ramasami, Novi, MI (US); Gary Edward Henige, Northville, MI (US); Sleiman N. Abdelnour, Macomb, MI (US)

(73) Assignee: Ford Global Technologies, LLC

(21) Appl. No.: 14/808,529

(22) Filed: Jul. 24, 2015

(51) Int. Cl. F21S 8/10; B60Q 1/14

(52) U.S. Cl. CPC F21S 48/13; B60Q 1/1423; F21S 48/115; F21S 48/1172; F21S 48/1225

(57) ABSTRACT

A vehicle headlamp assembly is provided herein. The headlamp assembly includes a housing including a transmissive portion on a first end and a reflector on an opposing end. The housing also defines an interior cavity. A first light source is configured to emit a first, lower intensity wavelength of light and a second, higher intensity wavelength of light and is disposed within the cavity. A second light source is configured to emit the first and the second wavelengths of light are also disposed within the cavity.

### FIELD OF THE INVENTION

The present invention generally relates to vehicle headlamp assemblies, and more particularly to vehicle headlamp assemblies employing multi-beam headlamps.

### BACKGROUND OF THE INVENTION

Headlamps that satisfactorily illuminate the road ahead of a vehicle without causing glare have long been sought to provide safety benefits during low light operation of a vehicle. It is therefore desired to implement headlamps that include advantageous features for better illuminating the area proximate the front of a vehicle.

### SUMMARY OF THE INVENTION

According to one aspect of the present invention, a vehicle headlamp assembly is disclosed. The vehicle headlamp assembly includes a housing defining an interior cavity. The housing includes a light transmissive portion and a reflector. The housing also defines an interior cavity. A first light source is disposed within the cavity and configured to emit a first, lower intensity wavelength of light and a second, higher intensity wavelength of light. A second light source is also disposed within the cavity and configured to emit the first and the second wavelengths of light disposed.

According to another aspect of the present invention, a headlamp system for a vehicle is disclosed. The headlamp system includes a first headlamp housing defining a first cavity therein. A plurality of multiple-beam light sources is disposed within the first cavity. The headlamp system also includes a second headlamp housing defining a second cavity therein. A plurality of multiple-beam light sources is disposed within the second cavity. The second housing is disposed on an opposing side of a vehicle centerline to the first housing. A pair of reflectors is disposed within each of the first and second housings and configured to direct the light emitted from each light source in a desired beam pattern.

According to yet another aspect of the present invention, a headlamp assembly is disclosed. The assembly includes a housing defining first and second cavities. The first cavity is disposed above the second cavity. A first light source configured to emit first and second intensities of light is disposed within the first cavity. A second light source configured to emit first and second intensities of light is disposed within the second cavity. An electrical connector is electrically coupled to a controller disposed within the vehicle for controlling an activation state of each light source in response to at least one vehicle-related condition.

These and other aspects, objects, and features of the present invention will be understood and appreciated by those skilled in the art upon studying the following specification, claims, and appended drawings.

### BRIEF DESCRIPTION OF THE DRAWINGS

In the drawings:

FIG. 1 illustrates a perspective view of a front fascia of a vehicle employing a headlamp assembly according to one embodiment;

FIG. 2A is an exemplary vehicle headlamp low-beam lighting pattern;

FIG. 2B is an exemplary vehicle headlamp high-beam lighting pattern;

FIG. 3 is a front perspective view of the headlamp assembly according to one embodiment;

FIG. 4 is a cross-sectional view taken along line IV-IV of FIG. 3 illustrating a headlamp housing employing a pair of multi-beam light sources in a first and second cavity;

FIG. 5 is an exemplary cross section of a multi-intensity light source in cooperation with a reflector according to one embodiment; and

FIG. 6 is block diagram of the vehicle and the headlamp assembly.

### DETAILED DESCRIPTION OF THE PREFERRED EMBODIMENTS

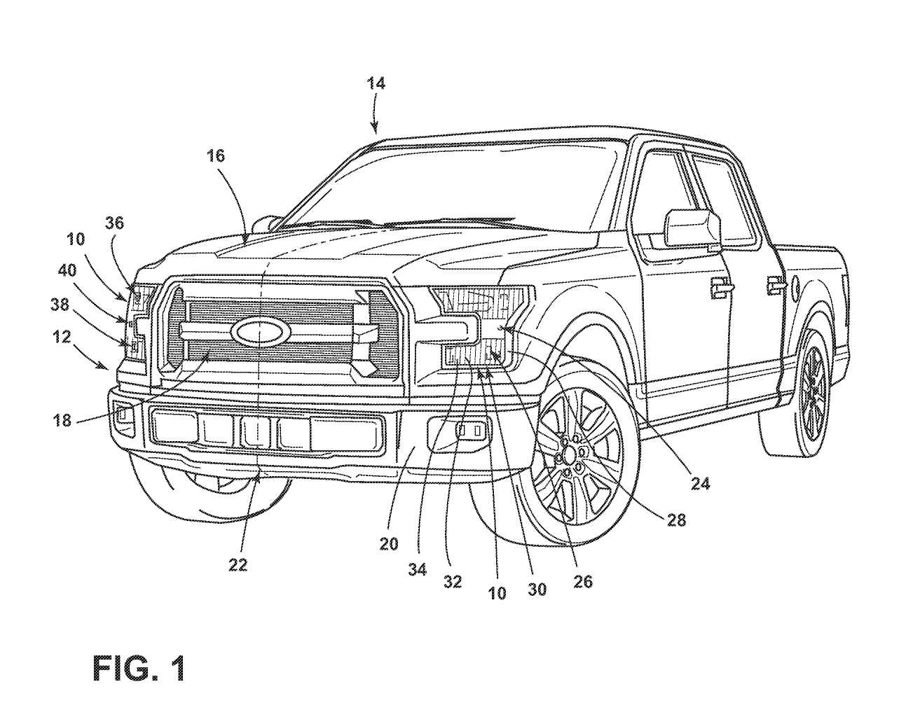

For purposes of description herein, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

As required, detailed embodiments of the present invention are disclosed herein. However, it is to be understood that the disclosed embodiments are merely exemplary of the invention that may be embodied in various and alternative forms. The figures are not necessarily to a detailed design and some schematics may be exaggerated or minimized to show function overview. Therefore, specific structural and functional details disclosed herein are not to be interpreted as limiting, but merely as a representative basis for teaching one skilled in the art to variously employ the present invention.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

The following disclosure describes a headlamp assembly configured to illuminate an area forwardly of a vehicle. The headlamp assembly may advantageously employ a plurality of multi-beam headlamps on each left and right side of the front of the vehicle to illuminate a targeted area in response to pre-defined events. The plurality of multi-beam headlamps may be configured to cooperate so as to form uniform high and low-beam patterns 44, 46.

Referring to FIG. 1, a perspective view of an automotive headlamp assembly 10 installed in a front portion 12 of a vehicle 14 is illustrated. The front portion 12 of the vehicle 14 may also include an engine compartment 16, a grille 18, a bumper 20, and/or any additional components. As illustrated, a pair of headlamp assemblies 10 is installed on either side of a lateral centerline 22 of the front of the vehicle 14 to form a vehicle headlamp system.

The headlamp assembly 10 includes a housing 24 defining at least one cavity 26. The housing 24 includes an outer surface 28 and a reflector 30. The outer surface 28 substantially encompasses the components of the headlamp assembly 10 and provides appropriate fixation members for fixing the headlamp assembly 10 to a desired location on the vehicle 14. The outer surface 28 may also protect the headlamp assembly 10 from physical and chemical damage arising from environmental exposure.

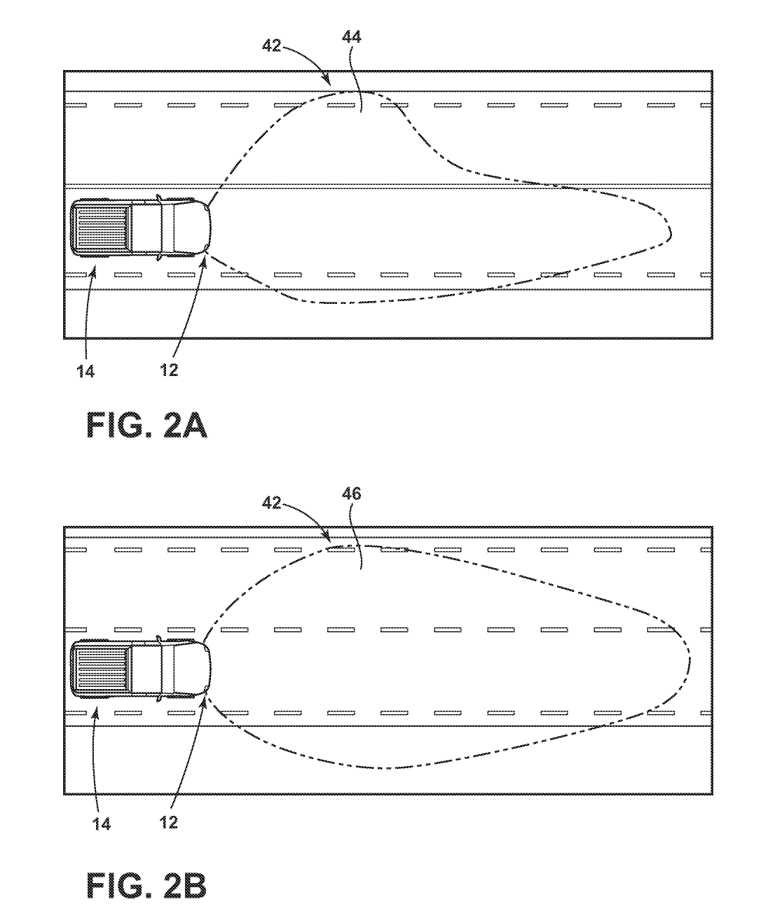

The reflector 30 may extend along at least part of a contoured inner surface of the housing 24. The reflector 30 may be formed from a polymeric material or any other suitable material known in the art. The reflector 30 may include low and high-beam reflector surfaces 32, 34. The low-beam reflector surfaces 32 are shaped to generate a low-beam lighting pattern 44 (FIG. 2A). The high-beam reflector surfaces 34 are shaped to generate a high-beam lighting pattern 46 (FIG. 2B). It should be appreciated that the reflector 30 may be one or more separate components disposed within the housing 24.

The headlamp assembly 10, as shown, includes first and second multi-beam light sources 36, 38, and a third light source (e.g., a turn signal) therein. It should be appreciated, however, that any other illumination device may be disposed within the headlamp assembly 10 positioned on any portion of the vehicle 14 (e.g., the front portion 12 of the vehicle 14). It should be appreciated that any and/or all of the light sources 36, 38, 40 disposed on the front portion 12 of the vehicle 14 may be in a single housing 24, or alternatively, may all be independently disposed in separate housings 24.

It is noted that the headlamp assembly 10 described herein is adapted to be coupled to the front portion 12 of the vehicle 14 on either the left-hand or right-hand sides of the vehicle centerline 22. The left-hand and right-hand headlamp assemblies 10 will function in a similar manner having nearly identical componentry. The headlamp assemblies 10 may be mirror images of each other as disposed on opposing sides of the vehicle 14. However, it should also be appreciated that the headlamp assemblies 10 on opposing sides of the vehicle 14 may not be mirror images of each other so as to form a desired beam pattern 42 (FIGS. 2A-2B). For example, the reflectors 30 disposed within the left-hand headlamp assembly 10 may be positioned asymmetrically to the reflectors 30 in the right-side headlamp assembly 10 to create the desired beam pattern 42.

Referring to FIG. 2, the Federal Motor Vehicle Safety Standard (FMVSS) 108 for vehicle lighting requires headlamps to generate high-beam and low-beam patterns 44, 46 defined by an array of points at each of which the beams are required to have a specified intensity or to have an intensity in a specified range of intensities. The high-beam and low-beam patterns are defined by respective photometry requirements, each of which may be understood as specifying a beam intensity or range of intensities at each of a plurality of spatially separated co-planar points. A beam pattern 42 for a headlamp has points of intensity at locations specified by reference to a vertical reference line and a horizontal reference line. These two lines intersect on an optical axis of the headlamp after the optical axis is adjusted to be parallel to the longitudinal axis of the vehicle 14 on which the headlamp is mounted. The location is specified in degrees to the right or left of the vertical reference line, and above or below the horizontal reference line. When the beam is projected onto a screen 30 m away, one degree (0.017 radians) may correspond to a distance length of 0.52 m.

A low-beam pattern 44 is intended to illuminate the area forwardly of the vehicle 14 when meeting or closely following another vehicle. As illustrated in FIG. 2A, low-beam headlamps may be designed to project an asymmetrical pattern that provides adequate forward and lateral illumination but controls glare by limiting light directed towards preceding or oncoming drivers. For low-beam lighting, Federal Motor Vehicle Safety Standard (FMVSS) 108 currently specifies as the point of maximum intensity of the beam pattern 42 a point that is 2.0 degrees to the right of the vertical reference line, and 1.5 degrees below the horizontal reference line.

A high-beam is intended primarily for distance illumination and for use when not meeting or closely following other vehicles. High-beam headlamps allow center-weighted light distribution without any control over light directed toward any other highway users. For high-beam, FMVSS 108 currently specifies the intersection of the vertical and horizontal reference lines as the point of maximum intensity of the beam pattern 42. It is important to note that FMVSS 108 does not require the two beam patterns 44, 46 to have respective maximum intensities at these two locations, here called the specified hot points; it requires only that the two beam patterns 44, 46 have at least some specified respective intensities at those specified hot points. Thus it is possible to satisfy FMVSS 108 by providing beams that have the required intensities at the specified hot points, but actually have higher intensities elsewhere. According to one embodiment, the headlamp assembly 10 is configured to match the beam patterns 44, 46 illustrated in FIGS. 2A-2B with a pair of multi-beam light sources 36, 38 disposed on each lateral side of the front of the vehicle 14. Such a configuration may also extend desired portions of the beam patterns 44, 46 creating more advantageous lighting characteristics for the vehicle 14.

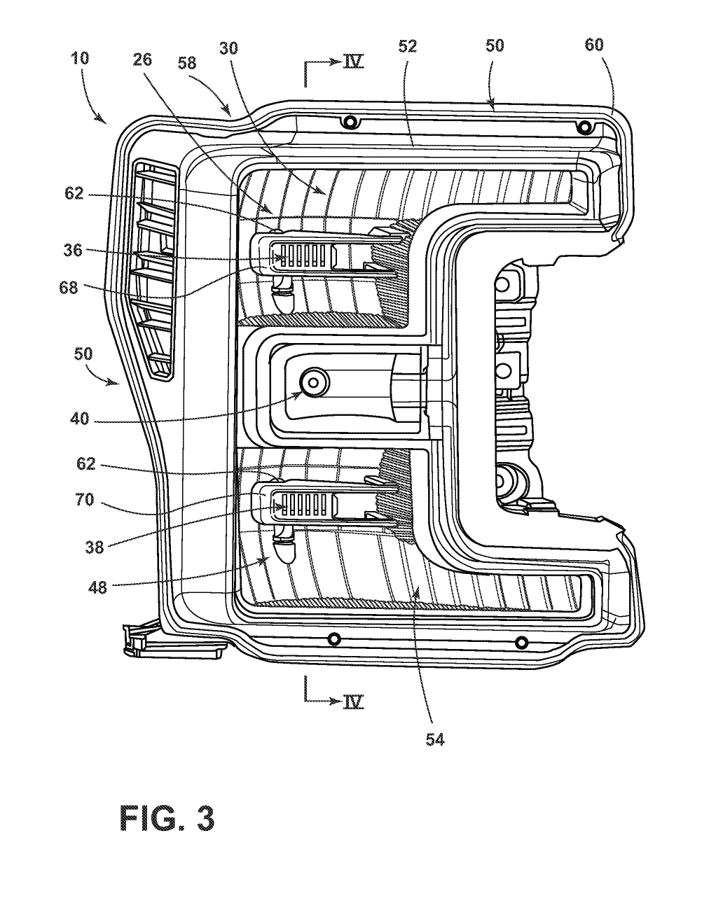

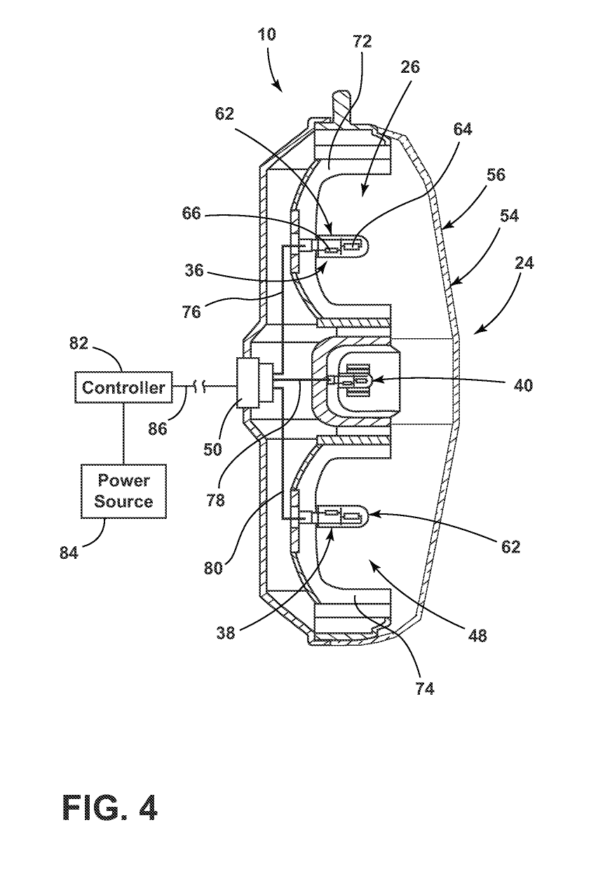

Referring to FIG. 3, an exemplary front view of a headlamp assembly 10 is illustrated. The housing 24 of the headlamp assembly 10 may include first and second light sources 36, 38, first and second cavities 26, 48, a reflector 30 disposed within each cavity 26, 48, an outer surface 28 and a bezel 52 partially surrounding a portion of the housing 24. The headlamp housing 24 may also include a light transmissive front portion 54 having a lens 56 (FIG. 4) disposed thereon as well as a rear portion 58 located rearwardly of the front portion 54. The front and rear portions 54, 58 may meet and form a sealed joint 60. The sealed joint 60 may protect the headlamp assembly 10 from physical and chemical damage arising from environmental exposure. The housing 24 may be formed from a polymeric material, or any other material known in the art.

As illustrated in FIG. 3, a first light source 36 is disposed in a first cavity 26 within the housing 24 and coupled to and supported by the housing 24. Likewise, a second light source 38 is disposed in a second cavity 48 within the housing 24 and also coupled to and supported by the housing 24. Each light source 36 may be capable of emitting light at a plurality of intensities.

According to one embodiment, the first and second light sources 36, 38 may be configured such that each light source 36 may produce high and low-beam patterns 44, 46. One such method of implementing both the high-beam and low-beam into a single light source 36 is by providing a bulb 62 with two filaments; a high-beam filament 64 (FIG. 4) and a low-beam filament 66 (FIG. 4). The high-beam filament 64 and the low-beam filament 66 are fixed in a predetermined relation with reflecting surfaces 32, 34 so that light generated from each of the filaments 64, 66 is optically coupled with the reflector surfaces 32, 34 to form an image surface in a known manner thereby creating any desired lighting pattern.

Accordingly, the vehicle 14 may include four light sources 36, 38, each independently capable of providing a high-beam and a low-beam for illumination forwardly of the vehicle 14. It should be appreciated, however, that the vehicle 14 may include additional light sources 40 that illuminate an area forwardly of the vehicle 14. The additional light sources 40 may be configured as single beam or multi-beam light sources. Alternatively, the first and second light sources 36, 38 may be configured such that low and high-beam reflector surfaces 32, 34 cooperate to provide the full low beam 44 and/or high beam 46 pattern when first and second light sources 36, 38 are simultaneously illuminated.

Still referring to FIG. 3, a third light source 40 is disposed between the first and second light sources 36, 38. The third light source 40 may be configured for usage as an identifier light source that alerts occupants of proximate vehicles of a specific vehicle-related condition, such as the vehicle turn signal. It should be appreciated, however, that the third light source, and any additional light sources 40, may have any function and may illuminate for any desired reason.

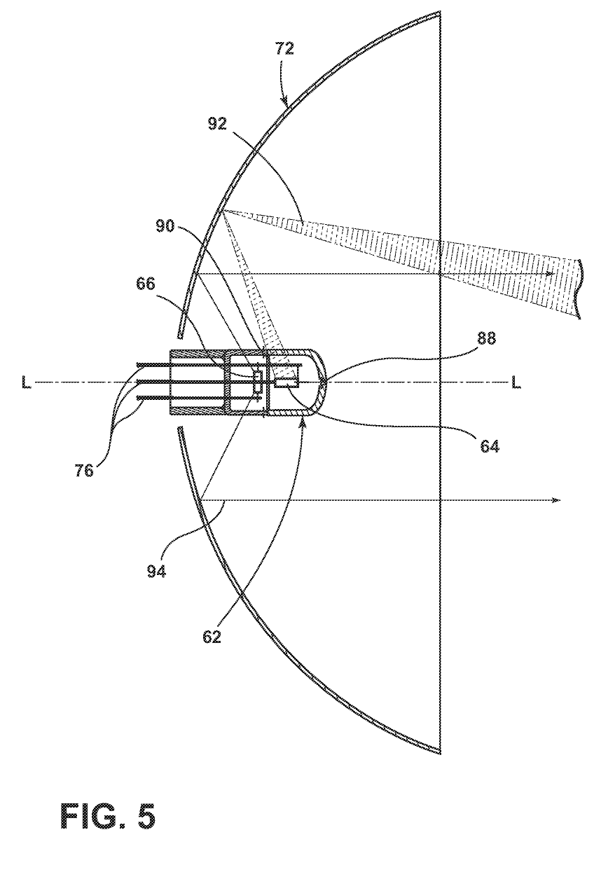

The light sources 36, 38 produce light rays 92, 94 (FIG. 5) that reflect off of the low and high-beam reflector surfaces 32, 34, and project forward through the lens 56, if utilized, in the low and high-beam patterns 44, 46 to illuminate an area forward of the vehicle 14. According to one embodiment, the light sources 36, 38 are a high intensity discharge (HID) light bulb. Alternatively, the light sources 36, 38 may be configured as light emitting diodes (LEDs) to take advantage of the relative low cost and low power consumption attributable to types of LEDs.

A pair of light shields 68, 70 may be disposed in front of the respective first and second light sources 36, 38. The light shields 68, 70 are configured to block incident light from the light source(s) 36, 38 from projecting forwardly of the vehicle 14. The light shields may be additional components of the headlamp assembly 10, may be integrally formed with the housing 24, or may be disposed on each light source 36 depending on the specific componentry of the headlamp assembly 10 utilized.

According to one embodiment, the first and second light sources 36, 38 simultaneously illuminate in cooperation to form a combined, uniform beam pattern 42. Moreover, the simultaneous illumination of the first and second light sources 36, 38 may also provide an appearance of symmetrical illumination projecting from the headlamp housing 24 while the light sources 36, 38 form a low-beam or high-beam pattern 44, 46 by illuminating a substantial portion of the housing 24.

The rear portion 58 of the housing 24 may include at least one electrical connector 50 which provides electrical connection to an associated light source 36 that shines light forwardly of the vehicle 14. Each light source 36, 38 disposed in the headlamp assembly 10 may also be positioned in any orientation such that a desired beam pattern 42 may be formed. As illustrated, the first and second light sources 36, 38 are laterally outboard in respect to the center point of each respective cavity 26, 48 with each light source 36, 38 positioned upwardly.

Referring to FIG. 4, an exemplary cross-sectional view taken along the line IV-IV of FIG. 3 illustrates the headlamp assembly 10 including a pair of multi-beam light sources 36, 38. The headlamp assembly 10 includes two light sources 36, 38 each configured as a bulb 62 capable of providing high-beam and low-beam light patterns 44, 46 for a vehicle 14.

The housing 24 may include a plurality of cavities 26, 48, each having at least one light source 36 therein. As illustrated, the housing 24 includes two cavities 26, 48 containing a first and second light source 36, 38. The cavities 26, 48 may be substantially symmetrical. Alternatively, the first and second cavities 26, 48 may vary in shape for design purposes or to create a desired beam pattern 42. As illustrated, the first cavity 26 has an asymmetrical reflector 72 along a vertical centerline to project light downwardly in respect to the center line of the reflector 72. The second cavity 48, conversely, is configured with a more symmetrical reflector 74 such that the light may project along a vertical center line of the second reflector 74.

As discussed above, the first and second light sources 36, 38 may be dual filament bulbs 62, wherein each filament 64, 66 is carried in a fixed special relationship to the other. In such a configuration, each light source 36, 38 may produce both at least a high-beam 46 and a low-beam 44. Further, the first and second light sources 36, 38 have a substantially similar shape, power output, and power input requirements. It is contemplated, however, that each light source 36, 38 may vary in specifications from any other light source 36, 38 in the housing 24 to create any desired beam pattern 42.

The headlamp assembly 10 further includes electrical connectors 76, 78, 80 connecting each light source 36, 38, 40 to a central electrical connector 50. In alternate embodiments, however, a central electrical connector 50 need not be utilized. The central electrical connector 50 is electrically coupled to a controller 82 and a power source 84 via conductive leads 86. In this manner, the first and second light sources 36, 38 may be selectively activated using the controller 82 to cause each light sources 36, 38 to illuminate at a desired intensity. For example, the controller 82 may activate the first and second light sources 36, 38 at a first intensity to create a low-beam pattern 44. Alternatively, the controller 82 may activate the first and second light sources 36, 38 at a second intensity resulting in a high-beam pattern 46. Alternatively still, the controller 82 may activate the first and second light sources 36, 38 independently to create a plurality of additional beam patterns 42. The intensities of light emitted from each light source 36, 38 may also be proportionally varied to one another such that additional variations may be obtained.

A vehicle 14 may use a plurality of multi-beam light sources 36, 38 on either side of the vehicle 14 to obtain advantageous lighting conditions. According to one embodiment, the headlamp assembly 10 described herein may produce a low-beam light collection of approximately 730-750 lumens compared to the 500 lumens of a traditional lighting system. The headlamp system described herein may also produce a high-beam light collection of approximately 1000-1100 lumens compared to the 700 lumens of a traditional lighting system. Moreover, the headlamp assembly 10 may produce a low-beam range and width of approximately 105-115 meters and 25-28 meters, respectively, versus to 102 meters and 23 meters of a traditional lighting system. Similarly, the headlamp assembly 10 described herein may produce a high-beam range of approximately 180-190 meters versus 179 meters for a traditional lighting system.

The advantageous lighting characteristics of the headlamp assembly 10 may cause a driver, or occupant, of a vehicle 14 employing the headlamp assembly 10 described herein to see more light forwardly of the vehicle 14 when utilizing low and high-beams. The occupants may also see a wider and longer area illuminate forwardly of the vehicle 14 when the light sources 36, 38 are illuminated.

Referring to FIG. 5, a light source 36 configured as a dual filament bulb 62 is illustrated. The bulb 62 has a substantially tubular shape, in which a first filament 66 and a second filament 64 are arranged therein. The second filament 64 is located in the axis L-L of the lamp and the first filament 66 is positioned transversely of the lamp axis L-L.

At one end, the bulb 62 may have a curved surface that may include a point 88 for focusing light emitted therefrom. The opposing end of the bulb 62 includes a sealing portion that includes connectors 76 and any additional components of the bulb 62. The electrical connectors 76 provide power to and may support the filaments 64, 66 disposed within the bulb 62. A portion of the electrical connectors 76 extend through the sealing portion and couple to the central electrical connector 50. The bulb 62 may further include a screen 90. According to one embodiment, the screen 90 may be configured as a material within the bulb 62 that prevents light from reflecting off undesired portions of the reflector 72. Alternatively, the screen 90 may be configured in the form of a layer of paint on a surface of the bulb 62.

Exemplary light rays 92, 94 are illustrated for indicating the cooperation between the first light source 36 and the reflector 72. It should be appreciated that the second light source, which may be disposed within the same housing 24 may operate in a similar manner, as could the headlamp assembly 10 disposed on any other portion of the vehicle 14. The rays 94 emitting from the first filament 66 are emitted by the headlamp assembly 10 subsequent to reflection in a horizontal direction. A beam 92 from the second filament 64 may leave the headlamp in a downward direction due to the front position of the second filament 64. According to one embodiment, the rays 94 emanating from the second filament 64 lying beyond the range determined by the angle may not reflect off of the lower half of the reflector 72. This may be prevented by the screens 90.

According to one embodiment, the reflector 72 may have a substantially parabolic shape. However, it is contemplated that the reflectors 72 may have any practicable shape. For example, a complex-shaped nonparabolic reflector 72 may allow for the distribution of light for high and low-beam without the need for lens 56 and/or optics. This is accomplished by creating reflectors 72 with individual segments of specifically calculated, complex contours. Design and production of such reflectors 72 may require tight tolerances to maintain a desired beam pattern 42.

A light source 36 may be positioned at or near the focus of the reflector 72 (parabolic or of non-parabolic complex shape). Then a headlamp lens 56 with optics molded-in, is placed in front of the reflector 72, refracting (shifting) parts of the light vertically and laterally to produce the required pattern of light distribution, if a lens 56 is used in the headlamp assembly 10 being implemented. It should be appreciated that each light source 36 may have a unique lens 56, or all light sources 36, 38 may have a substantially similar lens 56 disposed proximately thereto.

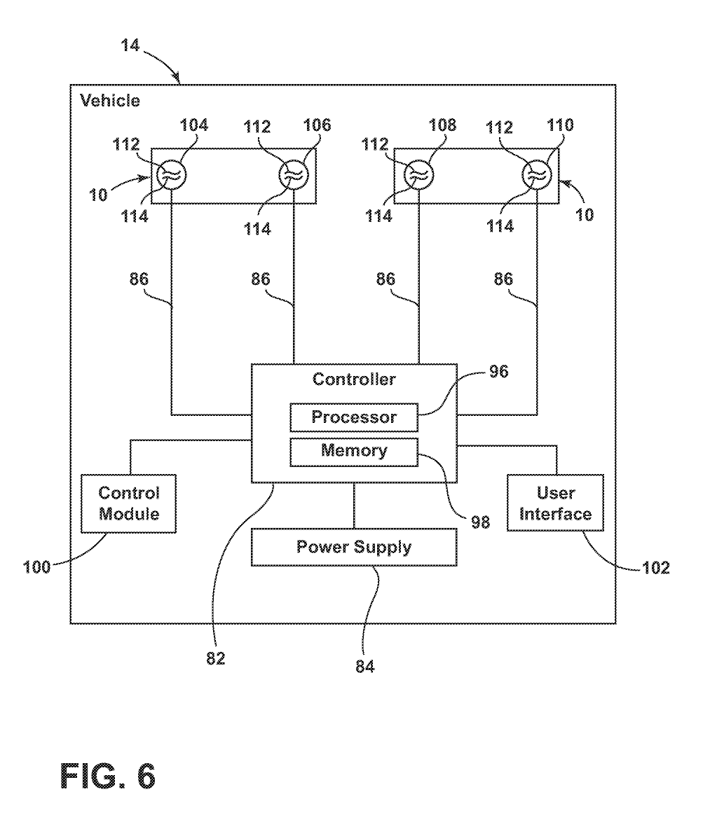

Referring to FIG. 6, a block diagram of a vehicle 14 is shown in which the headlamp assembly 10 is implemented having four multi-beam light sources 104, 106, 108, 110. Each light source 104, 106, 108, 110 is configured to produce at least a first 112 and second 114 intensity of light. The headlamp assembly 10 includes a controller 82 in communication with each of the light sources 104, 106, 108, 110. The controller 82 may include memory 98 having instructions contained therein that are executed by a processor 96 of the controller 82. The controller 82 may provide electrical power to the light sources 104, 106, 108, 110 via a power source 84 located onboard the vehicle 14. In addition, the controller 82 may be configured to control the light output of each light source 104, 106, 108, 110 based on feedback received from one or more vehicle control modules 100 such as, but not limited to, a body control module, engine control module, steering control module, brake control module, the like, and/or a combination thereof. By controlling the light output of each light source 104, 106, 108, 110, the headlamp assembly 10 may illuminate in a variety of intensities 112, 114 and patterns to provide a desired aesthetic appearance or a beam pattern 42 that better illuminates an area forwardly of the vehicle 14.

In operation, the controller 82 may prompt each light source 104, 106, 108, 110 to emit only a first, low intensity 112 wavelength of light to cause the plurality of multi-beam headlights to cooperate in forming a desired low-beam pattern 44. Alternatively, the controller 82 may prompt each light source 104, 106, 108, 110 to emit only a second, higher intensity 114 wavelength of light to cause the headlamps to cooperate in forming a high-beam pattern 46. Alternatively still, the controller 82 may prompt a first portion of the light sources 104, 106, 108, 110 to emit the first intensity and a second portion to emit the second, higher intensity wavelengths of light simultaneously to cause an alternate beam pattern.

In another embodiment, the headlamp assembly 10 may include a user interface 102. The user interface 102 may be configured such that a user may control the wavelength of light that is emitted by each light source 104, 106, 108, 110. The user interface 102 may be disposed within the vehicle 14 cabin or on any surface that is accessible to the user during utilization of the headlamp assembly 10 described herein. The user interface 102 may use any type of control known in the art for control the light source 104, 106, 108, 110, such as, but not limited to, proximity sensors or a user actuated member and/or switch extending outwardly from the steering column within the vehicle 14 cabin.

With respect to the above examples, the controller 82 may modify the intensity of the emitted first and second wavelengths of light by pulse-width modulation or current control. In some embodiments, the controller 82 may be configured to adjust the output of the emitted light by sending control signals to adjust an intensity or energy output level of the light sources 104, 106, 108, 110. The controller 82 may also modify the intensity output of each light source 104, 106, 108, 110 based on available power supply. For example, the vehicle 14 may reduce the intensity of light emitting from each light source 104, 106, 108, 110 when a vehicle engine, and hence the alternator coupled to the engine, is in the off state. The controller 82 may subsequently raise the intensity of each light source 104, 106, 108, 110 once the engine is placed in the running state. Alternatively, only a portion of the light sources 104, 106, 108, 110 may be illuminated when the engine is in the off state such that power consumption may be reduced.

According to one embodiment, a light sensor may dynamically monitor the headlamp assembly 10 and light sources 36 therein. As the headlamp assembly 10 described herein may illuminate a larger area, the sensor may monitor and dynamically alter the lighting characteristics of the headlamp assembly 10. For example, as an oncoming vehicle approaches vehicle approaches a vehicle 14 employing the headlamp assembly 10 described herein, the sensor may communicate with the controller 82 to vary the lighting characteristics of the vehicle 14. According to one implementation, the controller 82 may deactivate one of the light sources 36 within each housing 24 so that a smaller area is illuminated in front of the vehicle 14 until the oncoming vehicle passes, at which time the controller 82 may re-illuminate each light source 36 within each housing 24.

Though a low level and a high level of intensity are discussed in reference to the emitted light, it shall be understood that the intensity of the light may be varied among a variety of intensity levels to adjust the intensity corresponding to the emitted light from the headlamp assembly 10. By adjusting the range of intensities 112, 114 that may be emitted from each light source 104, 106, 108, 110; the plurality of multi-beam light sources 104, 106, 108, 110 described herein may be operable to generate a range of unique, aesthetic appearances and features for the headlamp assembly 10. It is also contemplated that the intensity of each light source 104, 106, 108, 110 may be varied simultaneously, or independently, from any number of other light sources 104, 106, 108, 110.

Accordingly, a headlamp assembly configured to illuminate an area forwardly of a vehicle has been advantageously provided herein. The headlamp assembly may advantageously employ a plurality of multi-beam headlamps on each side of the vehicle to illuminate a targeted area in response to pre-defined events. The plurality of multi-beam headlamps may be configured to cooperate so as to form a uniform beam pattern 42 having both functional and decorative characteristics.

For the purposes of describing and defining the present teachings, it is noted that the terms “substantially” and “approximately” are utilized herein to represent the inherent degree of uncertainty that may be attributed to any quantitative comparison, value, measurement, or other representation. The term “substantially” and “approximately” are also utilized herein to represent the degree by which a quantitative representation may vary from a stated reference without resulting in a change in the basic function of the subject matter at issue.

It is to be understood that variations and modifications can be made on the aforementioned structure without departing from the concepts of the present invention, and further it is to be understood that such concepts are intended to be covered by the following claims unless these claims by their language expressly state otherwise.

What is claimed is:

1. A vehicle headlamp assembly comprising:
a housing defining an interior cavity and including a light transmissive portion and a reflector, the housing defining an interior cavity;
a first light source disposed within the cavity and configured to emit a first, lower intensity wavelength of light and a second, higher intensity wavelength of light; and
a second light source disposed within the cavity and configured to emit the first and the second wavelengths of light.

2. The vehicle headlamp assembly of claim 1, wherein the first intensity wavelength is configured as a low-beam pattern.

3. The vehicle headlamp assembly of claim 1, wherein the second intensity wavelength is configured as a high-beam pattern.

4. The vehicle headlamp assembly of claim 1, further comprising:
a lens disposed on a front portion of the headlamp assembly for directing light emitted from the first and second light sources towards a desired location.

5. The vehicle headlamp assembly of claim 1, further comprising:
a first reflector optically coupled with the first light source; and
a second reflector optically coupled with the second light source.

6. The vehicle headlamp assembly of claim 1, wherein the first and second reflectors are configured such that a single beam pattern is formed when the first and second light sources simultaneously emit light.

7. The vehicle headlamp assembly of claim 1, further comprising:
a controller configured to control an activation state of the first and second light sources independently.

8. A headlamp system for a vehicle comprising:
a first headlamp housing defining a first cavity therein, wherein a plurality of multiple-beam light sources are disposed within the first cavity;
a second headlamp housing defining a second cavity therein, wherein a plurality of multiple-beam light sources are disposed within the second cavity, the second housing on an opposing side of a vehicle centerline to the first housing; and
a pair of reflectors disposed within each of the first and second housings configured to direct the light emitted from each light source in a desired beam pattern.

9. The vehicle headlamp system of claim 8, wherein the light source is configured as a dual filament bulb.

10. The vehicle headlamp system of claim 8, wherein the light source is configured as a light emitting diode capable of emitting varying intensities of light.

11. The vehicle headlamp system of claim 8, further comprising:
a lens disposed on a front portion of the headlamp assembly for directing light emitted from the first and second light sources towards a desired location.

12. The vehicle headlamp system of claim 8, further comprising:
a first reflector optically coupled with the plurality of multiple-beam light sources disposed within the first cavity; and
a second reflector optically coupled with the plurality of multiple-beam light sources disposed within the second cavity.

13. The vehicle headlamp system of claim 12, wherein the first and second reflectors are configured such that a single beam pattern is formed when the first and second light sources simultaneously emit light.

14. The vehicle headlamp system of claim 8, further comprising:
a controller configured to control an activation state of the light source.

15. A headlamp assembly comprising:
a housing defining first and second cavities, wherein the first cavity is disposed above the second cavity;
a first light source configured to emit first and second intensities of light disposed within the first cavity;
a second light source configured to emit first and second intensities of light disposed within the second cavity; and
an electrical connector electrically coupled to a controller disposed within the vehicle for controlling an activation state of each light source in response to at least one vehicle-related condition.

16. The vehicle headlamp assembly of claim 15, wherein the controller determines at least one of a light emission intensity and a light emission duration of each of the light source.

17. The vehicle headlamp assembly of claim 15, wherein the first intensity is configured as a low-beam pattern.

18. The vehicle headlamp assembly of claim 15, wherein the second intensity is configured as a high-beam pattern.

19. The vehicle headlamp assembly of claim 15, wherein the controller is configured to control each light source independently.

20. The vehicle headlamp assembly of claim 15, wherein the pair of reflectors each a first portion for reflecting light at the first intensity and a second portion for reflecting light at the second intensity.
